(19) United States
(12) Patent Application Publication
(10) Pub. No.: US 2005/0097337 A1
(43) Pub. Date: May 5, 2005

(54) Systems and methods for providing recipient-end security for transmitted data

(76) Inventors: Robert Sesek, Meridian, ID (US); Erika Lee Molchan, Meridian, ID (US); Dale Richard Young JR., Kuna, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/700,147

(22) Filed: Nov. 3, 2003

(51) Int. Cl. H04K 1/00

(52) U.S. Cl. 713/186

(57) ABSTRACT

Disclosed are systems and methods for providing recipient-end security for transmitted data. In one embodiment, a system and a method pertain to scanning a hard copy document to generate scanned data, configuring the scanned data so as to require recipient-end security, transmitting the scanned data to an intended recipient, determining if the transmitted data may be accessed at the recipient end, and denying access to the transmitted data if it is determined that the transmitted data may not be accessed.

### BACKGROUND

There are several technologies with which hard copy documents can be electronically transmitted from a sender to a recipient. Perhaps most commonly used is facsimile technology in which a document is scanned and the scanned data then transmitted across an analog telephone line. More recently, other technologies have become available. One such technology that shows particular promise is so-called “digital sending” technology in which a document is scanned and then digitally transmitted across a network, often as a file attachment to an email message. The digitally sent document file (e.g., a portable document format (PDF)) file) can then be opened by the recipient from his or her email program.

Whenever data is transmitted across a telephone line or network, the data is susceptible to interception and access by unintended and/or unauthorized recipients. Because of this susceptibility, security measures are often employed to protect such data transmissions. For instance, in the case of a facsimile transmission, a secure line may be used to transmit the data. In the case of a digitally sent document, the document may be generically encrypted in some manner to reduce the likelihood of unauthorized interception and therefore access of the data.

Although such security measures help to maintain the secrecy of transmitted data, those measures are not effective in every situation. For example, if a document is faxed to a facsimile machine that is accessible to multiple persons (e.g., one located in an unlocked office or a shared facsimile machine), it is possible for unintended recipients to obtain the document even if a secure line is used. In similar manner, if a document is digitally sent to an intended recipient and the transmission encrypted to protect the data while in transit, it is still possible that an unintended recipient could access the document simply by accessing the intended recipient's computer.

From the foregoing, it can be appreciated that it would be desirable to provide recipient-end security that helps prevent unauthorized persons from accessing transmitted data.

### SUMMARY OF THE DISCLOSURE

Disclosed are systems and methods for providing recipient-end security for transmitted data. In one embodiment, a system includes means for configuring scanned data representative of a hard copy document so as to require recipient-end security at a recipient end of a transmission path, means for determining if the scanned data may be accessed at the recipient end by requiring at least one of recipient-specific security information and machine-specific security information, and means for denying access to the transmitted data if it is determined that the required security information is not correct.

In one embodiment, a method includes scanning a hard copy document to generate scanned data, configuring the scanned data so as to require recipient-end security, transmitting the scanned data to an intended recipient, determining if the transmitted data may be accessed at the recipient end, and denying access to the transmitted data if it is determined that the transmitted data may not be accessed.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system with which recipient-end security can be provided for transmitted data.

FIG. 2 is a block diagram of an embodiment of a sender-end data transmitting device shown in FIG. 1.

FIG. 3 is a block diagram of an embodiment of a recipient-end data receiving device shown in FIG. 1.

FIGS. 4A and 4B comprise a flow diagram that illustrates an embodiment of a method for providing recipient-end security for transmitted data.

FIG. 5 is a flow diagram that illustrates an embodiment of operation of a sender-end security manager of the data transmitting device of FIG. 2.

FIGS. 6A and 6B comprise a flow diagram that illustrates an embodiment of operation of a recipient-end security manager of the data receiving device of FIG. 3.

### DETAILED DESCRIPTION

As described above, transmitted data, such as that representing a hard copy document, is susceptible to access by unauthorized persons even when conventional security measures, such as secure lines and generic transmission encryption, are used. This susceptibility is particularly problematic at the recipient end of the communication path. As is disclosed herein, however, recipient-end security can be provided by at least requiring recipient-specific security information be provided prior to permitting access to the transmitted data. As is discussed in greater detail below, such recipient-specific security information can, for example, comprise one or more of recipient-provided textural information or recipient biometric information.

Disclosed herein are embodiments of systems and methods for providing recipient-end security for transmitted data. Although particular embodiments are disclosed, these embodiments are provided for purposes of example only to facilitate description of the disclosed systems and methods.

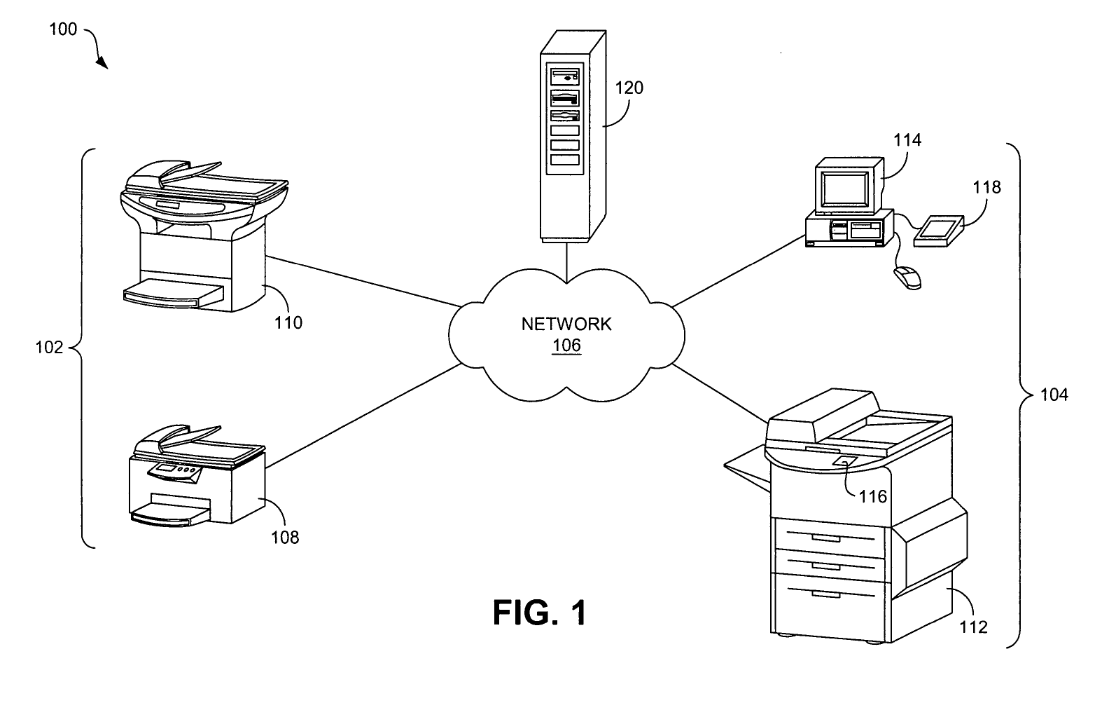

Referring now in more detail to the drawings, in which like numerals indicate corresponding parts throughout the several views, FIG. 1 illustrates an example system 100. As indicated in that figure, the system 100 generally comprises one or more sender-end data transmitting devices 102 and one or more recipient-end data receiving devices 104 that are linked together with a network 106. Although the terms “data transmitting device” and “data receiving device” are used, the data transmitting devices may further be capable of receiving data and the data receiving devices may further be capable of transmitting data. Therefore, those terms are selected not to limit the disclosure but to facilitate discussion of system operation.

In the embodiment of FIG. 1, two transmission devices 102 are shown including a facsimile machine 108 that is configured to send scanned data to another facsimile machine or other printing device, and a multi-function peripheral (MFP) device 110 that is configured to send scanned data to a computer or a printing device (e.g., a printer, another MFP device, etc.). In similar manner, two data receiving devices 104 are shown in FIG. 1. In the illustrated embodiment, these data receiving devices 104 comprise a printing device 112 (e.g., a printer) that is configured to receive transmitted data and generate hard copy printouts that contain that data, and a computer 114 (e.g., a personal computer (PC)) that is configured to receive transmitted data and present that data to the recipient, for instance in the form of an email message attachment.

As is further indicated in FIG. 1, each data receiving device 104 may comprise or be connected to a security data input device. For instance, the printing device 112 includes an input device 116 that is integrated into the printing device control panel, and the computer 114 includes a peripheral input device 118 that is connected to the computer. Those devices are configured to receive biometric information from the intended recipient prior to providing access to given transmitted data.

The network 106 normally comprises multiple sub-networks that are communicatively coupled to each other. By way of example, the network 106 comprises one or more local area networks (LANs) and one or more wide area networks (WANs) that comprise part of the Internet. In some embodiments, the data transmitting devices 102 and the data receiving devices 104 may be connected to separate LANs (e.g., a first LAN in a first office and a second LAN in a second office).

Also included in the embodiment of FIG. 1 is a network-accessible server 120. This server 120 may, for example, be connected to a LAN to which the data transmitting devices 102 and/or data receiving devices 104 are connected, or may be accessible via the Internet. As is described in greater detail below, the server 120, when provided, can store security information for use in providing security for transmitted data.

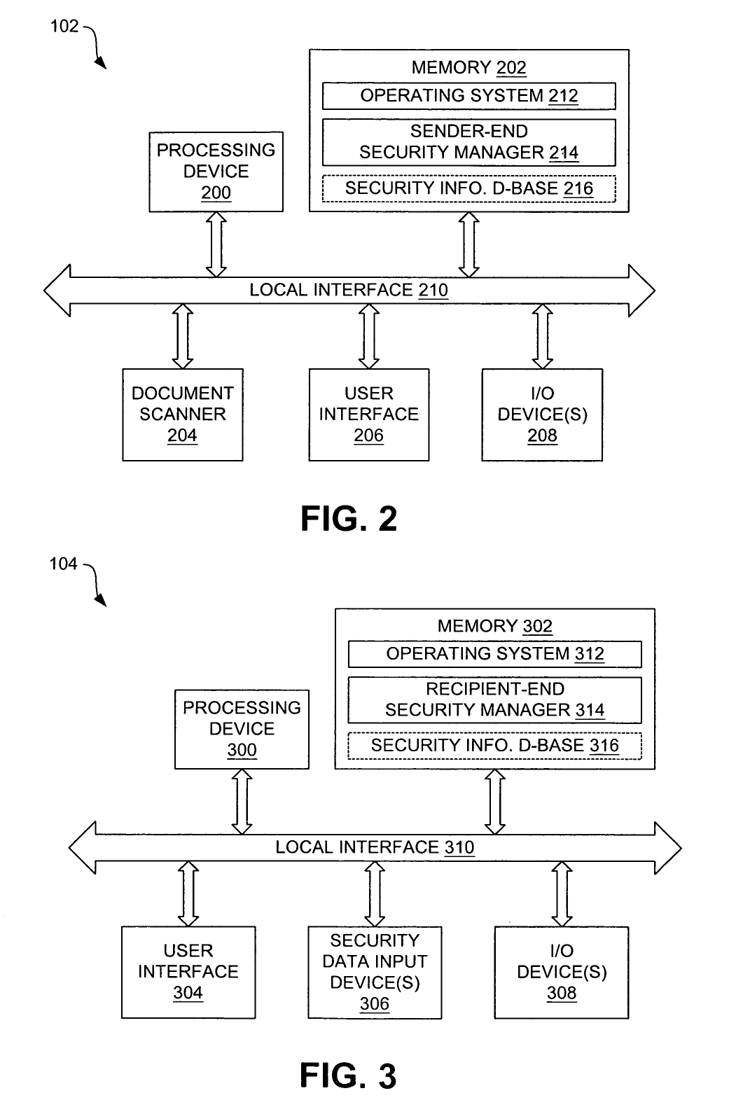

FIG. 2 is a block diagram illustrating an example architecture for a data transmitting device 102 shown in FIG. 1. As indicated in FIG. 2, the data transmitting device 102 comprises a processing device 200, memory 202, a scanner 204, a user interface 206, and at least one input/output (I/O) device 208. Each of these components is connected to a local interface 210 that, by way of example, comprises one or more internal buses.

The processing device 200 is adapted to execute commands stored in memory 202 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the data transmitting device 102. The memory 202 comprises any one or a combination of volatile memory elements (e.g., random access memory (RAM)) and nonvolatile memory elements (e.g., read-only memory (ROM), Flash memory, hard disk, etc.).

The scanner 204 is configured to scan hard copy documents to generate data that can be transmitted to an intended recipient. By way of example, the scanner 204 can comprise a flatbed scanner that includes a glass platen, various optics (lenses, mirrors, etc.), one or more drive motors, and one or more image sensors (e.g., charge-coupled devices (CCD)). Although a scanner 204 is illustrated in FIG. 2 and explicitly described herein, the data transmitting device 102 may, alternatively, not comprise a scanner and may instead be configured to receive previously-scanned data and transmit it to the intended recipient.

The user interface 206 comprises the tools with which the device settings can be changed and through which the user can communicate commands to the data transmitting device 102. By way of example, the user interface 206 comprises one or more function keys contained within a device control panel. Such a control panel may further include a display, such as a liquid crystal display (LCD) or light emitting diode (LED) display.

The one or more I/O devices 208 facilitate communications with other devices over the network 106, such as the network-accessible server 120 and/or the data receiving devices 104, and therefore may include a modulator/demodulator (e.g., modem), network card, wireless (e.g., radio frequency (RF)) transceiver, or other such communication components.

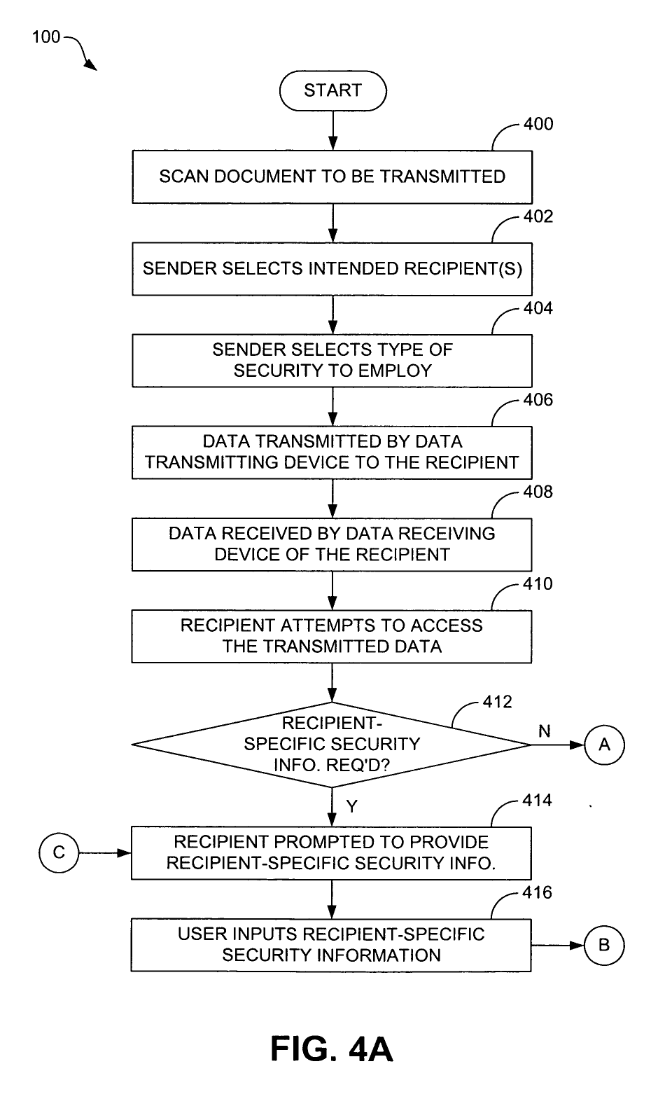

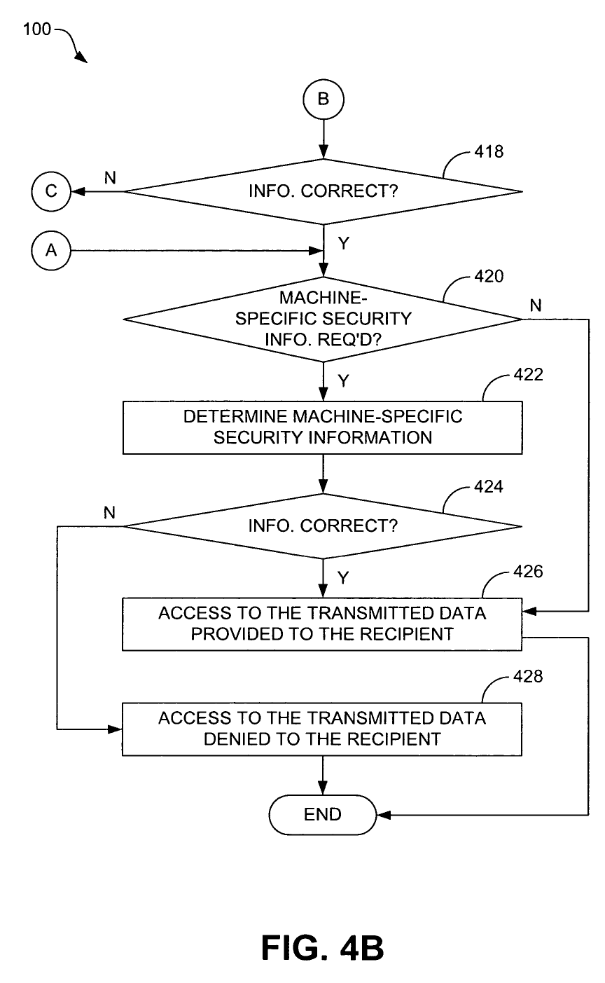

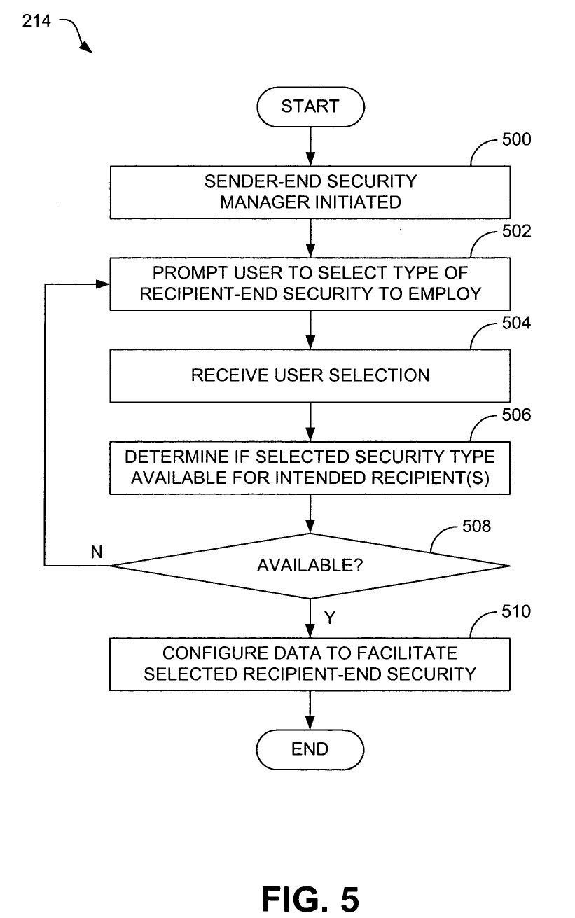

The memory 202 includes various programs including an operating system 212 and a sender-end security manager 214 that, as is described below, comprises logic that is configured to enable the sender to limit access to transmitted data by specifying various security information that must be provided and/or detected at the recipient-end of the transmission path prior to gaining such access. Operation of the sender-end security manager 214 is discussed in greater detail in relation to FIGS. 4 and 5 below.

In addition to those components, the memory 202 may further include a local security information database 216 that may be accessed by the sender-end security manager 214 when enabling the sender to limit access to the transmitted data. Notably, that database 216, or a similar database, may be maintained on the network-accessible server 120.

FIG. 3 is a block diagram illustrating an example architecture for a data receiving device 104 shown in FIG. 1. As indicated in FIG. 3, the data receiving device 104 comprises a processing device 300, memory 302, a user interface 304, a security data input device 306 (such as devices 116 and 118 in FIG. 1), and at least one I/O device 308, each of which is connected to a local interface 310.

The processing device 300 can include a central processing unit (CPU) or an auxiliary processor among several processors associated with the data receiving device 104, or a semiconductor based microprocessor (in the form of a microchip). In cases in which the data receiving device 104 comprises a printing device (e.g., printer, MFP, facsimile machine), the processing device 300 may comprise one or more ASICs. The memory 302, like memory 202 of the data transmitting device 102, includes any one of or a combination of volatile memory elements (e.g., RAM) and nonvolatile memory elements (e.g., hard disk, read only memory (ROM), tape, etc.).

The user interface 304 comprises the components with which a user interacts with the data receiving device 104. In cases in which the data receiving device 104 comprises a computer, the user interface may comprise a keyboard, mouse, and a display, such as a cathode ray tube (CRT) or liquid crystal display (LCD) monitor. In cases in which the data receiving device 104 comprises a printing device the user interface, like the user interface 206 of the data transmitting device 102, may comprise a control panel that includes one or more function keys contained within a device control panel. Such a control panel may further include a display, such as an LCD or an LED display and may also be touch sensitive.

The configuration of the security data input device(s) 306 depends upon the nature of the security information that is to be collected from the recipient of the transmitted data. For instance, in implementations in which the recipient is to provide a password or other textual data, a security data input device 306 may comprise part of the user interface 304 such as the keyboard, mouse, control panel, and/or display. Alternatively, in implementations in which the security information to be provided by the recipient comprises biometric information, a security data input device 306 may comprise any one or more of a thumb or fingerprint scanner, a retina scanner, or a microphone.

With further reference to FIG. 3, the one or more I/O devices 308 are adapted to facilitate network-based communications and therefore include one or more communication components such as a modulator/demodulator (e.g., modem), wireless (e.g., (RF)) transceiver, a telephonic interface, a bridge, a router, etc.

The memory 302 comprises various programs including an operating system 312 and a recipient-end security manager 314. The operating system 312 controls the execution of other programs and provides scheduling, input-output control, file and data management, memory management, and communication control and related services. The recipient-end security manager 314 comprises logic that is configured to provide security for transmitted data at the recipient end of the communication path. In some embodiments, the recipient-end security manager 314 may comprise any programming modules that are used to interpret the information received via the security data input device 306. Such programming modules may comprise, for example, a thumbprint analysis module, a retina analysis module, and/or a voice-recognition module.

Various programs have been described herein. These programs can be stored on any computer-readable medium for use by or in connection with any computer-related system or method. In the context of this document, a computer-readable medium is an electronic, magnetic, optical, or other physical device or means that contains or stores a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

Example systems having been described above, operation of the systems will now be discussed. In the discussions that follow, flow diagrams are provided. Process steps or blocks in these flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

As identified above, the described systems and methods can be used to provide recipient-end security for transmitted data such that the data may only be properly accessed by first presenting and/or possessing certain required security information. An overview of an example method for providing such security is described in relation to FIGS. 4A and 4B. Beginning with block 400 of FIG. 4A, a document to be transmitted to an intended recipient is scanned. This scanning can be accomplished using a sender-end data transmission device (e.g., one of the devices 102, FIG. 1) or another device in communication with sender-end data transmission device. Once the scanning has been performed, the content of the document is in electronic form so as to provide data suitable for transmission.

Next, with reference to block 402, the sender selects one or more intended recipients for the data. By way of example, the sender can manually enter a telephone number (e.g., in the case of a facsimile transmission) or an email address (e.g., in the case of a digital sending transmission) of each recipient using the user interface of the selected data transmission device. Alternatively, in cases in which the data transmitting device includes or can access a stored contacts list, the intended recipient(s) can be selected from such a list. Alternatively, a list of telephone numbers and/or email addresses could be transmitted to the device by the user of the device (e.g., wirelessly from a PDA or laptop).

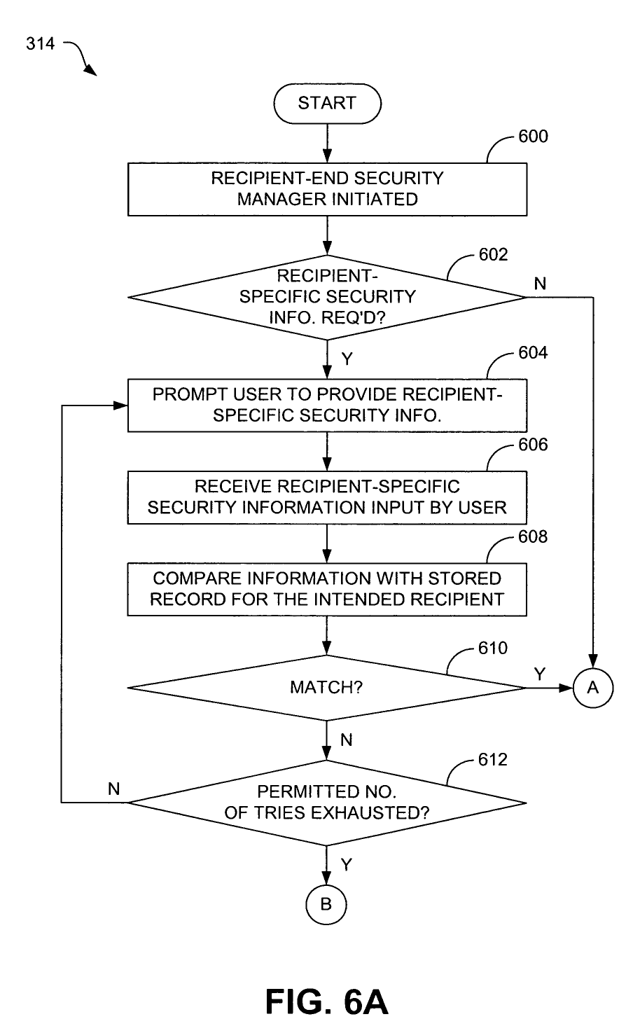

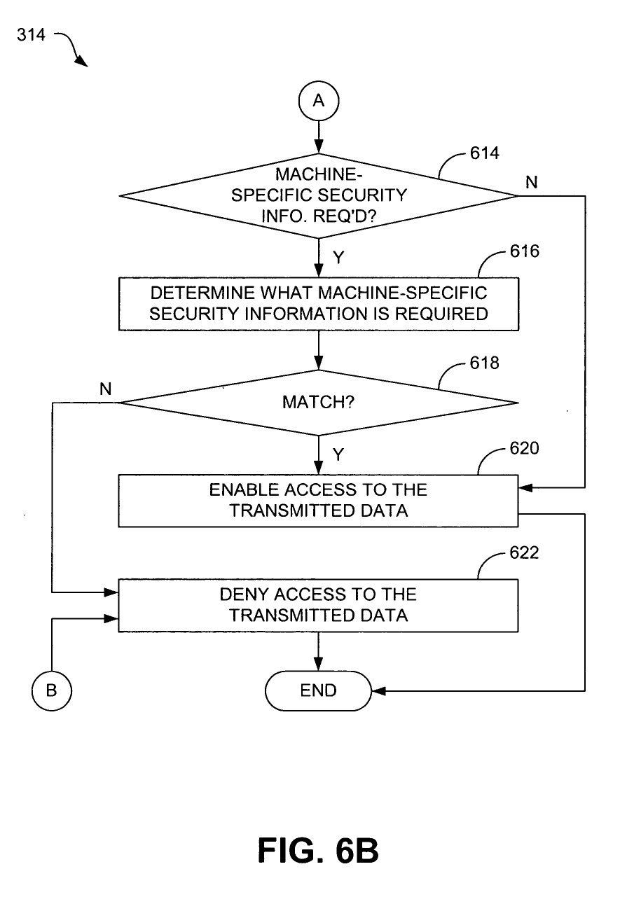

In addition to selecting the intended recipient(s), the sender can select the type of security to employ for the data transmission, as indicated in block 404. More particularly, the sender can select the security information that will be required at the recipient end of the communication path (e.g., telephone network or data network) to access the transmitted data. Examples of the various types of information that may be required are described below in relation to FIGS. 5 and 6. Generally speaking, however, this information may comprise recipient-specific security information and/or machine-specific security information.

Once the desired security has been selected, the data is transmitted by the data transmitting device to the recipient, as indicated in block 406. Notably, conventional transmission security measures can be employed for the transmission. For example, a secure line can be used and/or generic encryption can be used to scramble the data while in transit. The transmitted data then is received by the data receiving device of the recipient, as indicated in block 408. The data receiving device can comprise, for example, a printing device (e.g., printer, MFP, facsimile machine) that is configured to generate a hard copy document with the data, or a computer (e.g., PC) that is configured to receive email communications and present them to the recipient using an appropriate email program.

With reference next to block 410, the recipient (whether the intended recipient or an unintended, i.e. unauthorized, recipient) attempts to access the transmitted data. For instance, the recipient may attempt to print a hard copy printout of the transmitted data from a printing device, or may attempt to open an email attachment comprising the transmitted data. Flow from this point depends upon the security information that was required to access the data (block 404). Referring to decision block 412, it is determined whether the required security information comprises recipient-specific security information. If so, flow continues to block 414 at which the user is prompted to provide the recipient-specific security information. This information can, for instance, be requested using a display of the printing device, or with a pop-up dialog box of the computer, as the situation may warrant.

The user then inputs the requested recipient-specific security information, as indicated in block 416. This security information can be provided, for example, using the data receiving device user interface and/or using a security data input device integrated into or associated with the data receiving device. Once that information is entered by the user, it is determined whether the information is correct, as indicated in decision block 418 of FIG. 4B. In particular, it is determined whether the input information matches security information on record for the intended recipient. If the information is not correct, flow returns to block 414 of FIG. 4A at which the information is again requested. Such a loop may be repeated a number of times if the recipient does not provide the correct recipient-specific security information. After a given number of attempts (e.g., three), access may be denied to the recipient (not shown).

Assuming that the recipient-specific security information is correct or, if at decision block 412 of FIG. 4A, no such recipient-specific security information is required, flow continues to decision block 420 at which it is determined whether machine-specific security information is required. If not, flow continues down to block 426 described below. If, on the other hand, machine-specific information is required, flow continues to block 422 at which it is determined whether the machine-specific security information is correct for the data receiving device with which the data was received. With reference to decision block 424, if the machine-specific security information is not correct, flow continues down to block 428 and access to the transmitted data is denied. If the machine-specific security information is correct or, if at decision block 420, no such machine-specific security information is required, flow continues to block 426 at which access to the transmitted data is provided to the recipient. In cases in which the data receiving device is a printing device, a hard copy document is then output that contains the transmitted data. In cases in which the data receiving device is a computer, a data file attached to a transmitted email message is opened for the recipient. At this point, flow for the transmission session is terminated.

FIG. 5 provides an example of operation of the sender-end security manager 214 of a sender-end data transmitting device 102 (FIG. 2). Beginning with block 500 of FIG. 5, the security manager 214 is initiated. This initiation can occur, for instance, upon the user (i.e. sender) selecting an option, via the user interface 206, to provide recipient-end security to a data transmission. Once initiated, the security manager 214 prompts the user for the type of recipient-end security that is to be provided, as indicated in block 502. As was described in relation to FIGS. 4A and 4B, the type of security selected determines the type of security information that will be required of the recipient to access the transmitted data. Notably, the user may specify that the required security information include recipient-specific security information and/or machine-specific information.

For the purposes of this disclosure, the term “recipient-specific security information” denotes information that is presumably only known or otherwise unique to the intended recipient and that the recipient can affirmatively enter upon request as a prerequisite to accessing transmitted data. By way of example, the recipient-specific security information can comprise a password that the recipient uses to logon to a given system (e.g., a global logon password such as a Windows NT logon password). Such a password could, alternatively, comprise an encryption password in a private key or public key encryption scheme. The recipient-specific security information can also comprise biometric information. For instance, the information may pertain to the unique characteristics of the intended recipient's thumb or fingerprints, retina configuration, voice pattern, or the like.

As used herein, the term “machine-specific security information” denotes information that is particular to a given machine (i.e. data receiving device) and which can be determined at the recipient end to ensure that the transmitted data is only available on certain machines, regardless of whether the intended recipient has been verified. Such machine-specific security information may comprise, for example, an Internet protocol (IP) address of the machine, a media access control (MAC) address of the machine, or any other information that identifies the machine with particularity. Notably, although the system password mentioned above has been identified as comprising recipient-specific security information, in some cases it may also be regarded as machine-specific security information. For example, if the intended recipient has already logged on to a given system at a given data receiving device using his or her NT logon password, the device may be confirmed as proper if that NT logon password is automatically confirmed at the recipient end (i.e. any machine the intended recipient logs onto is deemed an “authorized” machine).

Once the recipient-end security has been selected, the selection is received, as indicated in block 504. At this point, the sender-end security manager 506 can determine if the selected security is available for the intended recipient or recipients. In particular, it is determined, for instance with reference to an appropriate database (e.g., security information database 216) whether the data receiving device of the recipient is configured to collect and/or provide the required security information. For example, if the user has selected to require biometric information, the security manager 214 will confirm that the recipient's data receiving device includes or is linked to an appropriate security data input device that can collect such biometric information, as indicated in block 506. In some embodiments, different forms of recipient-end security can be selected for different intended recipients (e.g., in the case of a distribution list). Therefore, for instance, recipient A can be required to provide a password, while recipient B can be required to provide biometric information and recipient B's machine will be evaluated to confirm that is an authorized machine. In still other embodiments, the recipient-end security determination can be automated such that the type of security available for each recipient is automatically selected based upon preconfigured recipient settings.

With reference to decision block 508, if the selected recipient-end security is not available, flow returns to block 502 and the user is given another opportunity to select the security that will be used. Assuming, however, that the recipient-end security is available, flow continues to block 510 at which the security manager 214 configures the data to be transmitted so as to facilitate the selected recipient-end security. The configuration that is performed depends upon the recipient-end security that is to be used. For instance, configuring the data may comprise adding information to the data transmission, such as a recipient password, an IP address, or a MAC address that can be used as a reference against which to compare security information provided or observed at the recipient end. Furthermore, configuring the data may comprise adding an executable to the data that, when activated (e.g., when someone attempts to access the data) performs various tasks to ensure that only an authorized recipient and/or machine can access the data. Alternatively, configuring the data may comprise adding instructions to the data that indicates to a recipient-end security manager what tasks are to be performed by that manager to provide the recipient-end security.

At this point, flow for the sender-end security manager 214 is terminated and the data may be transmitted to the recipient. In cases in which an executable is added to the transmitted data, the recipient-end security can be provided exclusively by the executable. For instance, assume the data transmission comprises an email message transmitted to a given machine and that the transmission includes an attached file. If the recipient attempts to access the data by trying to open the file, the executable may, for example, verify a password of the recipient and a MAC address of the machine. These tasks can be accomplished by the executable by prompting the user for the password and querying the machine for its MAC address. If both pieces of information match information contained in the data transmission (i.e., added in block 510) or if both pieces of information match information contained in a given database that the executable can access (either locally or remotely), the file may be opened and the data therefore accessed.

When an executable is included, as in the example provided above, no further security programs may be required on the recipient end to provide the desired security. In some embodiments, however, the recipient's data receiving device comprises the recipient-end security manager 314 shown in FIG. 3. Notably, this may be the case even when an executable is included in the transmission. FIGS. 6A and 6B provide an example of operation of the recipient-end security manager 314. Given that an added executable may operate in similar manner to the security manger 314, the flow diagram may, in some embodiments, likewise reflect operation of such an executable.

Beginning with block 600 of FIG. 6A, the recipient-end security manager 314 is initiated. This initiation can occur, for example, when a user (either the intended recipient or an unintended, i.e. unauthorized, recipient) attempts to access data that has been transmitted to the data receiving device 104. By way of example, the user may attempt to print out a document that contains the transmitted data after reading a data transmission reception notice posted in a display of a printing device. Alternatively, the user may attempt to open a file attached to an email message that the recipient received.

Once initiated, the security manager 314 determines, as indicated in decision block 602, whether recipient-specific security information is required to access the data. If not, flow continues to decision block 614 of FIG. 6B. If, on the other hand, recipient-specific security information is required, flow continues to block 604 at which the user is prompted to provide the recipient-specific security information. By way of example, the user may be prompted to enter textual information such as a password using the data transmitting device user interface. Alternatively, the user may be prompted to provide biometric information via the security data input device 306.

After the user inputs the requested recipient-specific security information, that information is received, as indicated in block 606, and is compared to a stored record for the intended recipients indicated in block 608. As mentioned above in relation to FIG. 5, the stored record may comprise information included with the transmitted data (e.g., password). In such a case, the security information collected by the security manager 314 can be compared to that information. Alternatively, the transmitted data may simply identify what information is to be verified. For instance, the transmitted data may merely comprise an instruction that biometric information of “John Williams” is to be verified prior to enabling the user to access the data. In such a case, the security manager 314 may compare the input security information (block 606) with a record stored in an accessible database (e.g., security information database 316 or a database of the network-accessible server 120) to confirm the user's identity and, therefore, authorization.

With reference next to decision block 610, if the user-provided security information matches that of a stored record for the intended recipient, flow continues on to decision block 614 of FIG. 6B. If not, however, flow continues to decision block 612 at which it is determined whether a permitted number of tries (e.g., three) has been exhausted. If not, flow returns to block 604 at which the user is again prompted to provide the recipient-specific security information. If all permitted tries have been exhausted, however, flow continues to block 622 of FIG. 6B at which the security manager 314 denies access to the transmitted data.

Referring next to decision block 614 of FIG. 6B, the security manager 314 determines whether machine-specific security information is required. If not, flow continues down to block 620 described below. If such information is required, however, flow continues to block 616 at which the security manager 314 determines the machine-specific security information that is required. The security manager 314 can, for example, obtain this information directly from the transmitted data (i.e. when that information was added to the data), or from an appropriate database (e.g., stored on the network-accessible server 120).

Next, the security manager 314 determines if there is a match between the required machine-specific security information and that of the machine on which the security manager executes. For instance, if the required security information comprises a particular NT logon password or IP or MAC address, the security manager 314 queries the data receiving device 104 (assuming that information is not already known by the security manager) and then compares a logged NT logon password, an IP address, or a MAC address of the data receiving device with the required information. With reference to decision block 618, if there is no such match, flow continues to block 622 and access to the transmitted data is denied. Therefore, scenarios are possible in which the intended recipient has been verified, but cannot access the data because that recipient is attempting to access it from an unauthorized machine.

Returning to decision block 618, if there is a match (or if no machine-specific security information was required in decision block 614), the user, presumably the intended recipient, is given access to the transmitted data, as indicated in block 620. Accordingly, the user may be able to obtain a hard copy printout or may be able to open an email attachment, as the case warrants.

1. A method for providing recipient-end security for transmitted data, the method comprising:
scanning a hard copy document to generate scanned data;
configuring the scanned data so as to require recipient-end security;
transmitting the scanned data to an intended recipient;
determining if the transmitted data may be accessed at the recipient end; and
denying access to the transmitted data if it is determined that the transmitted data may not be accessed.

2. The method of claim 1, wherein scanning a hard copy document comprises scanning a hard copy document using a data transmitting device that transmitted the scanned data to an intended recipient.

3. The method of claim 1, wherein configuring the scanned data comprises configuring the scanned data such that recipient-specific security information must be provided by a recipient of the transmitted data prior to accessing the transmitted data.

4. The method of claim 3, wherein configuring the scanned data comprises configuring the scanned data such that the recipient must provide at least one of a recipient password and recipient biometric information to access the transmitted data.

5. The method of claim 1, wherein configuring the scanned data comprises configuring the scanned data such that machine-specific security data must be verified prior to accessing the transmitted data.

6. The method of claim 5, wherein configuring the scanned data comprises configuring the scanned data such that at least one of a global logon password, an Internet protocol (IP) address, and a media access control (MAC) address of a data receiving device that received the transmitted data is verified.

7. The method of claim 1, wherein transmitting the scanned data comprises faxing the scanned data.

8. The method of claim 1, wherein transmitting the scanned data comprises digitally sending the scanned data as an email attachment.

9. The method of claim 1, wherein determining if the transmitted data may be accessed comprises verifying required recipient-specific security information provided by a recipient that intends to access the transmitted data.

10. The method of claim 9, wherein verifying required recipient-specific security information comprises verifying at least one of a recipient password and recipient biometric information.

11. The method of claim 1, wherein determining if the transmitted data may be accessed comprises verifying required machine-specific security information.

12. The method of claim 11, wherein verifying required machine-specific security information comprises verifying at least one of a global logon password, an Internet protocol (IP) address, and a media access control (MAC) address of a data receiving device that received the transmitted data is verified.

13. The method of claim 1, further comprising providing access to the transmitted data if it is determined that the transmitted data may be accessed at the recipient end.

14. The method of claim 13, wherein providing access comprises at least one of printing out the transmitted data and opening an email attachment that comprises the transmitted data.

15. A system for providing recipient-end security for transmitted data, the system comprising:
means for configuring scanned data representative of a hard copy document so as to require recipient-end security at a recipient end of a transmission path;
means for determining if the scanned data may be accessed at the recipient end by requiring at least one of recipient-specific security information and machine-specific security information; and
means for denying access to the transmitted data if it is determined that the required security information is not correct.

16. The system of claim 15, wherein the means for configuring comprise means for configuring the scanned data such that at least one of a recipient password and recipient biometric information is required to access the scanned data.

17. The system of claim 15, wherein the means for configuring comprise means for configuring the scanned data such that at least one of a global logon password, an Internet protocol (IP) address, and a media access control (MAC) address of a data receiving device that received the transmitted data is required to access the scanned data.

18. The system of claim 15, wherein the means for determining comprise means for verifying at least one of a recipient password and recipient biometric information.

19. The system of claim 15, wherein the means for verifying comprise means for verifying at least one of a global logon password, an Internet protocol (IP) address, and a media access control (MAC) address of a data receiving device that received the transmitted data is verified.

20. A system stored on a computer-readable medium, the system comprising:
sender-end logic adapted to execute on a data transmitting device, the sender-end logic being configured to configure data scanned by the data transmitting device so as to require recipient-end security at a recipient end of a transmission path; and
recipient-end logic adapted to execute on a data receiving device, the recipient-end logic being configured to determine if the scanned data may be accessed at the recipient end by verifying at least one of recipient-specific security information provided by a recipient of the scanned data and machine-specific security information of the data receiving device.

21. The system of claim 20, wherein the sender-end logic is configured to require at least one of a recipient password and recipient biometric information of the recipient prior to access of the scanned data.

22. The system of claim 20, wherein the sender-end logic is configured to require at least one of a global logon password, an Internet protocol (IP) address, and a media access control (MAC) address of a data receiving device that received the transmitted data is verified before a recipient access the scanned data.

23. The system of claim 20, wherein the recipient-end logic is configured to verify at least one of a recipient password and recipient biometric information prior to providing access to the scanned data.

24. The system of claim 20, wherein the recipient-end logic is configured to verify at least one of a global logon password, an Internet protocol (IP) address, and a media access control (MAC) address of a data receiving device that received the transmitted data prior to providing access to the scanned data.

25. A sender-end security manager stored on a computer-readable medium of a data transmitting device, the manager comprising:
logic configured to identify a type of recipient-end security to provide for a data scanned by the data transmitting device; and
logic configured to configure the scanned data to facilitate the identified type of recipient-end security.

26. The manager of claim 25, wherein the logic configured to configure the scanned data comprises logic configured to add security information to the scanned data that is to be used as a reference against recipient-specific security information entered by a recipient of the scanned data.

27. The manager of claim 25, wherein the logic configured to configure the scanned data comprises logic configured to add an executable that is configured to verify at least one of recipient-specific security information entered by a recipient of the scanned data and machine-specific security information of a data receiving device that received the scanned data.

28. The manager of claim 25, wherein the logic configured to configure the scanned data comprises logic configured to add an instruction to the scanned data that indicates to a recipient-end security manager what tasks are to be performed to provided recipient-end security.

29. A recipient-end security manager stored on a computer-readable medium of a data receiving device, the manager comprising:
logic configured to identify a type of recipient-end security that is required to access data that has been received by the data receiving device; and
logic configured to verify recipient-end security information prior to enabling access to the data.

30. The manager of claim 29, wherein the logic configured to verify recipient-end security information comprises logic configured to verify at least one of a recipient password and recipient biometric information.

31. The manager of claim 29, wherein the logic configured to verify recipient-end security information comprises logic configured to verify at least one of a global logon password, an Internet protocol (IP) address, and a media access control (MAC) address of the data receiving device.
